(19) United States
(12) Patent Application Publication
(10) Pub. No.: US 2013/0191850 A1
(43) Pub. Date: Jul. 25, 2013

(54) INTERCEPTING DATA

(71) Applicants: Anna Fischer, Bristol (GB); Aled Edwards, Charfield South (GB); Patrick Goldsack, Bristol (GB)

(72) Inventors: Anna Fischer, Bristol (GB); Aled Edwards, Charfield South (GB); Patrick Goldsack, Bristol (GB)

(21) Appl. No.: 13/355,114

(22) Filed: Jan. 20, 2012

(51) Int. Cl. G06F 3/00; G06F 9/46; G06F 13/00

(52) U.S. Cl. 719/313

(57) ABSTRACT

Disclosed herein is a technique that intercepts data transmitted from a first application executing in a first domain to a second application executing in a second domain.

### BACKGROUND

Virtual machines (“VM”) are software implementations of a computer executing in its own delineated domain within a real computer apparatus. A VM may start a BIOS and operating system different than that of the physical computer or host. Some applications may execute in the VM at the same time that different applications execute in the host computer. Applications executing in the VM often need to communicate with applications executing in the host computer. Virtualized systems heretofore utilize various solutions for carrying out communication between domains arranged within a host computer.

### BRIEF DESCRIPTION OF THE DRAWINGS

FIG. 1 illustrates an example of a computer apparatus in accordance with aspects of the present disclosure.

FIGS. 2A-B are flow diagrams of illustrative methods in accordance with aspects of the present disclosure.

FIG. 3 is a working example of inter-domain communication in accordance with aspects of the present disclosure.

FIG. 4 is a further working example of inter-domain communication in accordance with aspects of the present disclosure.

### DETAILED DESCRIPTION

As noted above, applications executing within the VM domain often need to communicate with applications executing in the physical domain of the computer apparatus; however, such communication may introduce security risks. For example, the computer may be vulnerable to an attacker who wishes to gain access thereto using resources that are shared with the VMs. If such attacker is able to use these shared resources to seize control of a host application with higher privileges than the VM application, the attacker may gain greater dominion over the physical host computer. The physical computer may also be vulnerable to any other type of program executing therein that may be exposed to attackers.

In view of the foregoing security risks, aspects of the present disclosure provide techniques for intercepting data transmitted by a first application executing in a first domain to a second application executing in a second domain. In another aspect, the intercepted data may be stored in a data buffer so as to permit the second application to read the data therefrom. In a further aspect, some resources of a computer apparatus may be protected from direct contact by the first application executing in the first domain. The aspects, features and advantages of the application will be further appreciated when considered with reference to the following description of examples and accompanying figures. The following description does not limit the application; rather, the scope of the application is defined by the appended claims and equivalents.

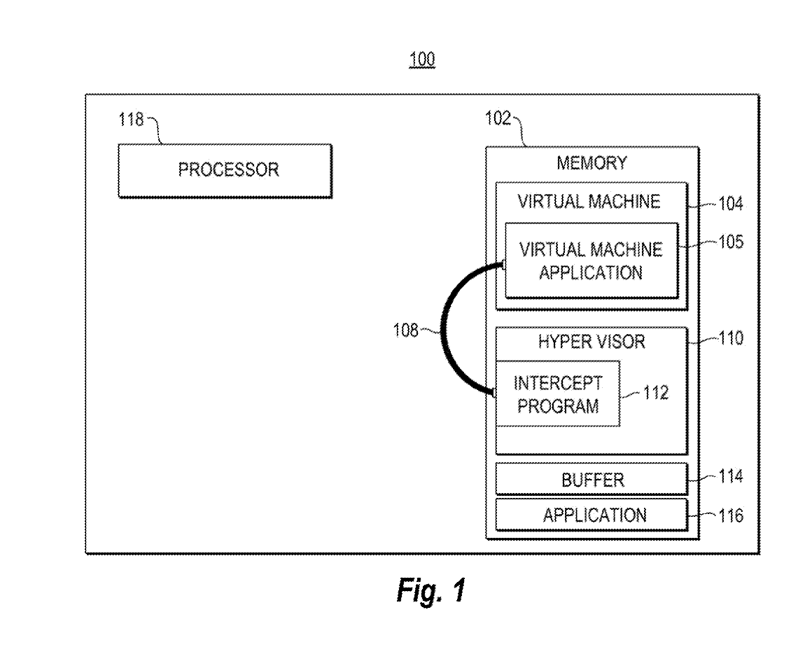

FIG. 1 presents an illustration of a computer apparatus 100, which may comprise any device capable of processing instructions and transmitting data to and from other computers. Computer apparatus 100 may include a laptop, a full-sized personal computer, or a high-end server. In the example of FIG. 1, computer apparatus 100 is shown having a processor 118, memory 102, and other components typically present in a computer. Other components may include a display (e.g., a monitor having a screen, a touch-screen, a projector, a television, a computer printer or any other electrical device that is operable to display information), and a user input (e.g., a mouse, keyboard, touch-screen or microphone). Memory 102 may be any type of device capable of storing information or instructions that may be retrieved, manipulated, executed, or stored by processor 118, such as a hard-drive or flash memories. The processor 118 may comprise any number of well known processors or a dedicated controller for executing operations, such as an ASIC.

The computer apparatus of FIG. 1 may be at one node of a network, which may be a local area network (“LAN”), wide area network (“WAN”), the Internet, etc. Such networks and intervening nodes thereof may use various protocols including virtual private networks, local Ethernet networks, private networks using communication protocols proprietary to one or more companies, cellular and wireless networks, instant messaging, HTTP and SMTP, and various combinations of the foregoing. For example, computer apparatus 100 may be a cloud server capable of communicating with a client computer such that the client computer uses a network to transmit information for presentation to a user. Accordingly, computer apparatus 100 may be used to generate requested information for display via, for example, a web browser executing on a remote computer.

Although FIG. 1 functionally illustrates the processor 118 and memory 102 as being within the same block, it will be understood that the processor and memory may actually comprise multiple processors and memories that may or may not be stored within the same physical housing. For example, any one of the memories may be a hard drive or other storage media located in a server farm of a data center. Accordingly, references to a processor, computer, or memory will be understood to include references to a collection of processors or computers or memories that may or may not operate in parallel.

FIG. 1 further shows instructions in memory 102 such as VM 104, hypervisor 110, VM application 105, and application 116. In that regard, the terms “instructions,” “programs,” or “applications” may be used interchangeably herein. In the example of FIG. 1, some applications executing in the computer apparatus (e.g., application 116) may have a higher privilege level than some of those (e.g., VM application 105) in the VM. As noted above, such configuration may permit an attacker to gain control of a higher privileged application in the host domain via resources shared with the VM domain. While the examples herein may make reference to communications between a VM application and an application executing in a computer apparatus, the techniques disclosed in the present disclosure may also be used for secure communications between different types of programs having different privilege levels in the computer apparatus.

Intercept program 112 may include instructions that cause processor 118 to carry out the security techniques disclosed herein. Intercept program 112 may be any set of instructions to be executed directly (such as machine code) or indirectly (such as scripts) by processor 118. The program may be stored in object code format for direct processing by the processor, or in any other computer language including scripts or collections of independent source code modules that are interpreted on demand or compiled in advance. However, it will be appreciated that examples herein can be realized in the form of software, hardware, or a combination of hardware and software. While intercept program 112 is depicted in FIG. 1 as a component of hypervisor 110, it is understood that intercept program 112 may be implemented as an independent, stand alone application. Functions, methods and routines of intercept program 112 are explained in more detail below.

In one example, intercept program 112 may be realized in any non-transitory computer-readable media for use by or in connection with an instruction execution system such as computer apparatus 100; an ASIC, or other system that can fetch or obtain, the logic from non-transitory computer-readable media and execute the instructions contained therein. “Non-transitory computer-readable media” may be any media that may contain, store, or maintain programs and data for use by or in connection with the instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, or a portable compact disc.

Virtualization may be used to maximize the capacity of servers. Operations of a virtualized system may occur in the physical computer apparatus or a VM hosted therein. Each VM may be associated with its own domain. A separate portion of memory 102 may be dedicated to each VM. FIG. 1 depicts one VM 104 that may be used to emulate a separate machine within computer apparatus 100. While only one VM domain is depicted, a plurality of VM domains may be implemented. The number of VMs may be limited by the capacity of computer apparatus 100 or by particular administrative policies. VM 104 may contain applications, such as VM application 105, which may serve the requests of remote computers on a network. For example, while the remaining portions of computer apparatus 100 may serve the requests of one remote computer on a cloud system, VM application 105 may simultaneously serve the requests of another remote computer. Each VM may serve additional client requests simultaneously and may act as an independent computer apparatus with an operating system different than that of the physical computer apparatus or of other VMs. Operating systems may represent a collection of programs that serve as a platform on which instructions can execute. Examples of operating systems include, but are not limited to, various versions of Microsoft's Windows® and Linux®.

Hypervisor 110 may manage allocation and virtualization of computer resources for the VMs and perform context switching, as may be necessary, to cycle between various VMs. Hypervisor 110 may dedicate a certain amount of resources in computer apparatus 100 to each of the VMs and manage the plurality of VMs to ensure they execute in parallel. The hypervisor 110 may be started either in a booting sequence of computer apparatus 100 or by execution of a hypervisor loader. During startup, VM 104 may be able to use the allocated resources to execute applications or operating systems. Hypervisor 110 may virtualize the underlying hardware of the computer such that use of the VM is transparent to the guest operating system or a remote computer communicating therewith.

Simulated open network port 108 may be a point-to-point connection established between an application in VM 104 and an application in computer apparatus 100. Such connection may provide a bidirectional data path therebetween. In one example, simulated open network port 108 may be a UDP/TCP socket bound to an address. However, as will be discussed further below, the port may be considered “simulated,” since data packets traveling therein may be intercepted before arriving at its destination. In another example, virtual serial links may be utilized in lieu of a UDP/TCP socket, such as Citrix Xen V4V or a VMWare VM communication interface (“VMCI”) enabled for inter-domain communication.

Data buffer 114 may be located at a predetermined address in memory 102 and may appear as a directory to a computer apparatus application, such as application 116. In one example, this may be accomplished through the use of a virtual file system (“VFS”), which may be an abstraction layer on top of a concrete file system. For example, a VFS may be used to access local and network storage devices transparently without application 116 noticing the difference. A VFS may be used to bridge differences in Windows, Mac OS and UNIX file systems, so that applications can access files thereof with no knowledge of the file system type. In one example, a file system known as “SYSFS” of kernel version 2.6, Linux™ may be utilized. SYSFS may reflect the information in data buffer 114 using a hierarchy of directories and files. Names and contents of such files and directories may encode information about the hardware configuration of computer apparatus 100.

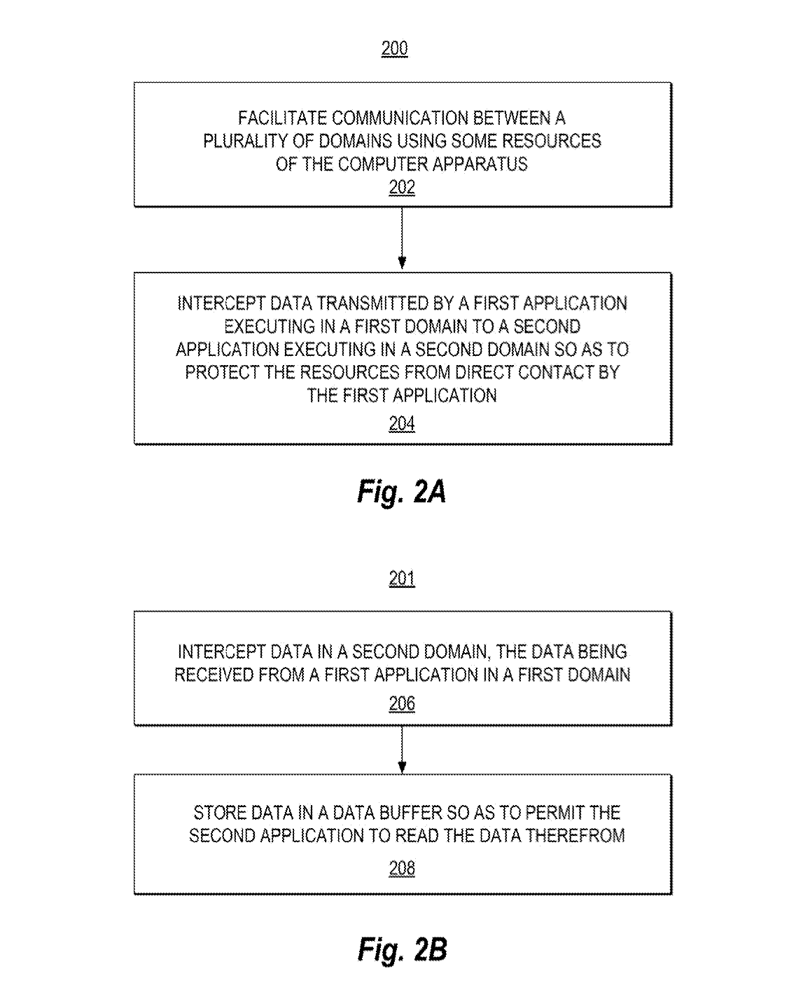

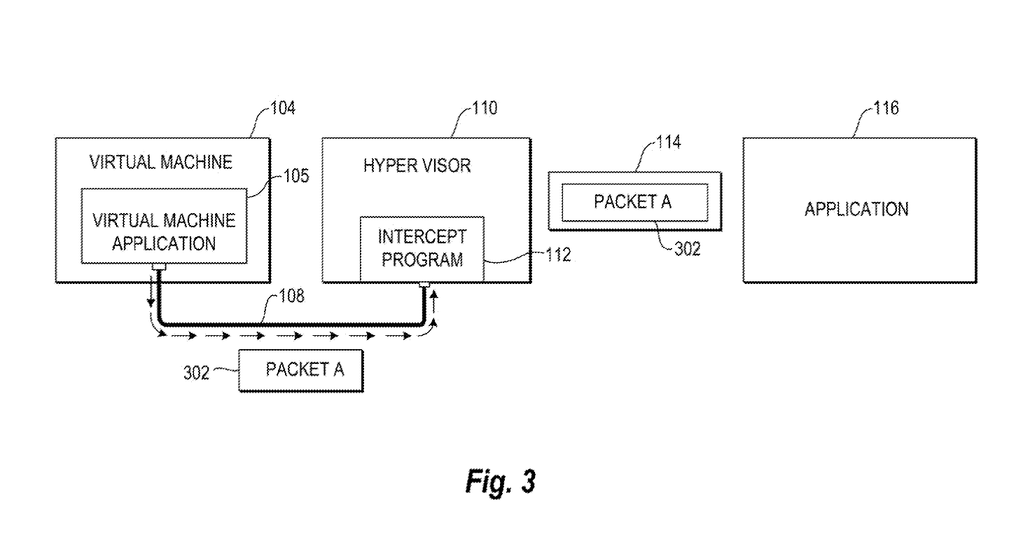

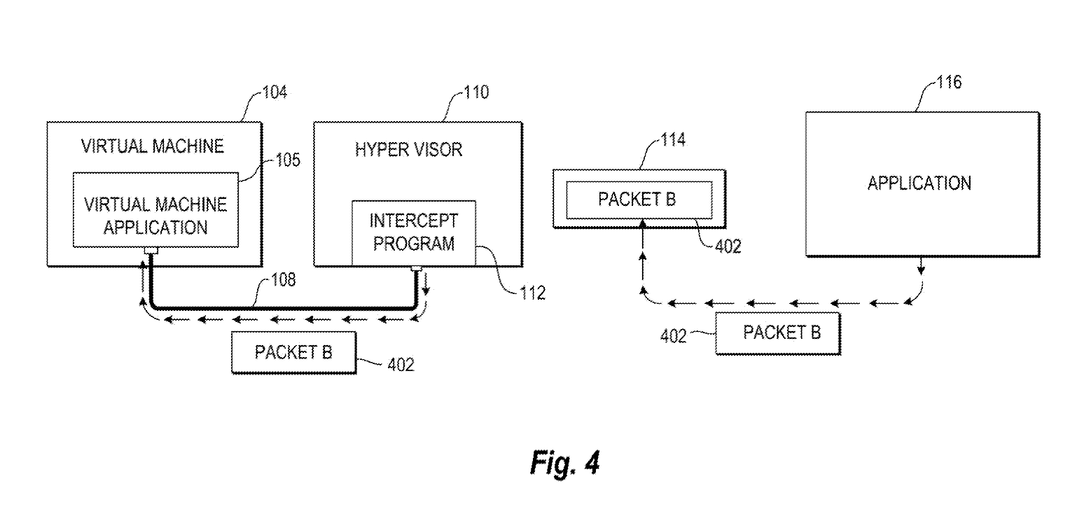

FIGS. 2A-B are flow diagrams of illustrative processes for inter-domain communication. FIGS. 3-4 are working examples that illustrate various aspects of inter-domain communication. The actions shown in FIGS. 3-4 will be discussed below with regard to the flow diagrams of FIGS. 2A-B.

Referring to process 200 of FIG. 2A, communication may be facilitated between a plurality of domains using some resources of a computer apparatus, as shown in block 202. Such resources may be data buffer 114. In the working example of FIG. 3, VM application 105 may be associated with a first domain (e.g., VM 104) and application 116 may be associated with a second domain (e.g., computer apparatus 100). Data may be transmitted between the two domains using simulated open network port 108. Referring back to FIG. 2A, data transmitted by a first application executing in a first domain to a second application in a second domain may be intercepted so as to protect the resources from direct contact by the first application, as shown in block 204. Referring back to the example of FIG. 3, application 116 of the computer apparatus may have permissions to write and read data to and from data buffer 114. However, VM application 105 may not have read or write permissions for data buffer 114. Data packets transmitted by VM application 105 may be blocked or intercepted by intercept program 112 before the packets directly contact data buffer 114 or application 116.

FIG. 2B is a flowchart of another illustrative process 201 in accordance with aspects of the present disclosure. As shown in block 206, data may be intercepted in the second domain, the data being received from a first application in a first domain. Referring back to the example in FIG. 3, intercept program 112 is shown executing in the second domain or outside VM 104. VM application 105 may transmit packet 302 via simulated open network port 108. VM 104 may identify the second domain as a remote computer with an internet protocol (“IP”) address. As noted above, simulated open network port 108 may be a UDP/TCP socket. In one example, VM application 105 and intercept program 112 may communicate with each other using routines contained in the socket application programmers interface (“API”). VM application 105 and intercept program 112 may listen for incoming packets navigating through simulated open network port 108 using, for example, the listen( ) function of the socket API. VM application 105 may have permissions to send and receive to and from simulated open network port 108. Unbeknownst to VM application 105, packet 302 may be intercepted or blocked by intercept program 112 so as to prevent direct access to data buffer 114 and application 116.

Referring back to FIG. 2B, the data may be stored in a data buffer so as to permit the second application to read the data therefrom, as shown in block 208. Referring back to FIG. 3, intercept program 112, which is shown executing in the second domain, may store the intercepted or blocked packet in data buffer 114. Unlike VM application 105, intercept program 112 may have permissions to read and write to and from data buffer 114. As noted above, the data may be exposed to an application on the computer apparatus using a VFS, such as SYSFS. SYSFS may reflect the information in data buffer 114 using a hierarchy of directories and files. Application 116 may read and write to and from data buffer 114 as it would to and from a file or a directory. Another potential advantage of the illustrative arrangement of FIG. 3 is that application 116 may read from data buffer 114 whenever it deems necessary. If simulated open network port 108 were a direct socket connection between VM application 105 and application 116, an incoming packet may trigger interrupt procedures within application 116. Such arrangement may render application 116 vulnerable to attackers attempting to destabilize application 116 by flooding it with data.

FIG. 4 shows an example of an application inserting a data packet into the VM. Here, application 116 may write packet 402 to a file in data buffer 114. The placement of packet 402 in data buffer 114 may trigger the intercept program to read the data therefrom and send packet 402 to VM application 105 via simulated open network port 108. However, it is understood that a separate program may be triggered to read and write from the data buffer and to send the data via simulated open network port 108. Computer apparatus 100 may also identify VM 104 as a remote computer with an IP address. VM application 105 may listen to incoming packets and receive packet 402, which was originally written to data buffer 114 by application 116.

Advantageously, the above-described apparatus and method protects host systems from attackers who utilize VMs or other programs to seize control of a computer apparatus. In this regard, virtualized systems on a network, such as a cloud network, will be more reliable for users that depend on secure virtualized systems. Furthermore, administrators of data centers hosting virtualized systems may provide their clients with better service.

Although the disclosure herein has been described with reference to particular examples, it is to be understood that these examples are merely illustrative of the principles of the disclosure. It is therefore to be understood that numerous modifications may be made to the illustrative examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. A computer apparatus comprising
a processor;
instructions which, if executed, cause the processor to:
facilitate communication between a plurality of domains using some resources of the computer apparatus; and
intercept data transmitted by a first application executing in a first domain to a second application executing in a second domain so as to protect the resources from direct contact with the first application.

2. The computer apparatus of claim 1, wherein the first domain is associated with a virtual machine executing within the computer apparatus.

3. The computer apparatus of claim 1, wherein the communication is facilitated using a simulated open network port, the second domain being identified as a remote computer by the first domain.

4. The computer apparatus of claim 3, wherein the resources include a data buffer.

5. The computer apparatus of claim 4, wherein the instructions, if executed, further cause the processor to:
store the intercepted data in the data buffer such that the second application is permitted to read the data therefrom.

6. The computer apparatus of claim 5, wherein the instructions, if executed, further cause the processor to transmit information from the second application to the first application using the data buffer.

7. The computer apparatus of claim 6, wherein the instructions, if executed, further cause the processor to transmit the information from the data buffer to the first application via the simulated open network port.

8. A non-transitory computer readable medium with instructions stored therein which, if executed, cause a processor to:
intercept data in a second domain, the data being received from a first application executing in a first domain, the data being directed to a second application executing in the second domain;
store the intercepted data in a data buffer so as to permit the second application to read the data therefrom; and
protect the data buffer from direct contact by the first application.

9. The non-transitory computer readable medium of claim 8, wherein the first domain is associated with a virtual machine executing within a computer apparatus.

10. The non-transitory computer readable medium of claim 8, wherein the data is transmitted using a simulated open network port.

11. The non-transitory computer readable medium of claim 10, wherein the first domain identifies the second domain as a remote computer accessible through the simulated open network port.

12. The non-transitory computer readable medium of claim 11, wherein the instructions, if executed, further cause the processor to:
store the intercepted data in the data buffer such that the second application is permitted to read the data therefrom.

13. The non-transitory computer readable medium of claim 12, wherein the instructions, if executed, further cause the processor to transmit the data from the data buffer to the first application via the simulated open network port, when the second application writes data thereto.

14. A method comprising:
intercepting data in a second domain, the data being received from a first application executing in a first domain, the data being directed to a second application executing in the second domain; and
storing the intercepted data in a data buffer so as to permit the second application to read the data therefrom.

15. The method of claim 14, wherein the first domain is associated with a virtual machine executing within a computer apparatus.

16. The method of claim 14, wherein the data is transmitted using a simulated open network port.

17. The method of claim 16, wherein the first domain identifies the second domain as a remote computer accessible through the simulated open network port.

18. The method of claim 17, further comprising:
storing the intercepted data in the data buffer such that the second application is permitted to read the data therefrom.

19. The method of claim 17, further comprising:
transmitting the data from the data buffer to the first application via the simulated open network port, when the second application writes data thereto.
